(19) United States
(12) Patent Application Publication
(10) Pub. No.: US 2006/0020812 A1
(43) Pub. Date: Jan. 26, 2006

(54) System and method of using human friendly representations of mathematical function results and transaction analysis to prevent fraud

(76) Inventors: Shira Steinberg, Teaneck, NJ (US); Joseph Steinberg, Teaneck, NJ (US)

Correspondence Address: KLAUBER & JACKSON, 411 HACKENSACK AVENUE, HACKENSACK, NJ, 07601, US

(21) Appl. No.: 11/114,945

(22) Filed: Apr. 26, 2005

Related U.S. Application Data
(60) Provisional application No. 60/565,744, filed on Apr. 27, 2004.

(51) Int. Cl. H04L 9/00; G06F 12/14; H04L 9/32; G06F 11/30

(52) U.S. Cl. 713/181; 713/189

(57) ABSTRACT

A system and method for identity authentication that comprises the use of a one-way mathematical (hash) value for log-in verification, user friendly graphical/audible verification representations of the same, and log/transaction monitoring that acts as a redundant check to avoid the subsequent execution of transactions that may have been fraudulently issued

### RELATED APPLICATIONS

The present application claims priority from U.S. Provisional Patent Application Ser. No. 60/565,744 filed on Apr. 27, 2004. Applicant claims priority under 35 U.S.C. §119 as to said U.S. application, and the entire disclosure of that application is incorporated herein by reference.

### BACKGROUND OF THE INVENTION

Various approaches have been proposed for combating different types of online identity-related fraud such as phishing. As commonly understood, phishing is the activity of fraudulently presenting oneself online as a legitimate enterprise in order to trick consumers into giving up personal financial information that will be used for either identity theft or other criminal activity. Phishing is most commonly perpetrated through the mass distribution of e-mail messages directing users to a web site (such as spurious “warnings” directing users to “log-in” to a given web site, etc.), but other venues are utilized as well. As those skilled in the art will recognize, phishing and other related online fraud is of widespread, growing concern, and has attracted the attention of the Federal Trade Commission, and has attracted increased major media attention.

Known approaches to stopping online identity-related fraud like phishing, tend to be overly simple in their approach to defeating what is a complex problem. In actuality, known approaches to have no comprehensive solution continuum that avoids the typical weaknesses of human users (e.g., gullibility, ignorance, etc.), or the usual weaknesses of “one-shot” technological approaches. By way of some illustration, current methods of combating phishing may include crude “solutions” such as: the issuance of instructions to humans not to fall prey to phishing scams; the maintaining on users' machines of a black-list of known phishing sites; the maintaining of a list of valid sites on users' machines; sending users secret passwords; utilization of so-called “email security systems”; requiring the use of site-specific cookies; etc. As those skilled in the art will readily appreciate, each of the above and others that may be found in the prior art are technologically and/or realistically deficient, and are failing to stem the occurrence of phishing and other related fraud.

### SUMMARY OF THE INVENTION

To this end, the present invention provides a system and method that offers at least the following advantages in that it: makes it nearly impossible for phishers to produce a login that looks like a legitimate login; does not rely on unrealistic human vigilance; and does not require site-specific software, emails, or lists that are often outdated, that may present technical issues for users running various other software, or considered a nuisance by users. The inventive solution provides the above by offering a human friendly representation of one way function mathematical values and by enabling a given online computer system of a transaction entity to progressively “build” a displayed image based on the user's credentials or other information as he types, but avoids the security concerns and maintenance issues inherent in server-based storage of passwords, etc. Alternatively, it may use audible sound representations or a combination of audio and visual cues. In all cases the representation may be built progressively, may involve multiple distinct representations, or may use a single representation. Under the present invention any given server utilizing the system and method described herein does not store or reveal any passwords (for authenticating the system to a user), and does not require that the user receive any secret information in the traditional sense. According to the present invention, the user can easily recognize if the displayed image or audible sequence or both is correct, and only he knows if the image being built or sounds being sounded (including potentially the reading of words) is the correct one because a one-way (cryptographic) hash (or other one-way mathematical function) is performed on the user's ID and password (or other text inputted by the user) and an easily recognizable or easily remembered color/shape/image/letter/number/other visual cue is displayed on the user's terminal and/or a sound sequence is heard. More advantageously, the invention may be utilized in an open platform, and in the case of an open platform, the solution allows an organization to implement the specific embodiments discussed herein according to its own standards, and the exemplary illustration provided herein provides for plug-and-plug installation for most scenarios. To this end, the present invention may also be utilized in numerous applications ranging from financial related applications, to CRM applications as well as to legal, medical, and other applications.

In sum, the present invention relates to an on-line identity authentication system that comprises the (optionally progressive) use of a hash or other one-way function for verification, user friendly graphical, visual, and/or audio representations of the same, and log/transaction/activity monitoring and analysis that avoids the subsequent fraudulent execution and settlement of transactions/activities, despite use of the hash-based protections described above (or if they were not utilized). In doing so, the invention offers a continuum of protection that comprises at least three components: (1) a unique approach to utilizing and representing a one-way mathematical function value (such as the exemplary “hash” or “one-way hash” as referenced herein) through a simple to understand representation (e.g., sounds, the reading of words, words displayed, colored symbols like shapes/letters/numbers on a background, numbers by thousands, changing the background and/or text color on the display, or other visual cues), the user-friendly aspects of which extend beyond applications pertaining to on-line verification for preventing phishing; (2) a unique, progressive “building out” of the aforementioned human friendly representation of a hash value on a user's screen (and/or speakers) as the user's key strokes are being entered; and (3) the unique component of practicing of subsequent intelligent log, activity, or transaction monitoring that adds a second level of protection against phishing and related types of fraud as even if users are somehow successfully phished, the phisher's activities may be caught by analysis of the logs/transactions/activities, so that fraud prevention may be maximized even after a user or users have successfully logged in to effectuate a transaction.

### DRAWING DESCRIPTION

FIG. 1 is one example of a general connectivity scheme between some illustrative elements involved and actors utilizing the present invention;

FIG. 2 is an illustrative flow diagram detailing some steps and potential routines involved in executing one implementation of the inventive method and system;

FIG. 3 is a continuation of the illustrative flow diagram detailing some steps and potential routines involved in executing the inventive method and system beginning in FIG. 2;

FIG. 4 is illustrative flow diagram detailing some steps and potential routines involved in executing an optional armor code embodiment of the inventive method and system;

FIGS. 5A and 5B are illustrative flow diagrams detailing some steps and potential routines involved in executing some possible forms of interaction between the transaction entity and the user when the user sends information and/or values within the general scheme of the inventive method and system; and

FIG. 6 illustrative flow diagram detailing some steps and potential routines involved in executing the log and transaction monitoring function within the inventive method and system.

### DETAILED DESCRIPTION

In its broadest description, the present invention is both a method for on-line identity authentication for an electronic system, comprising the steps of receiving identity indicia (the term identity indicia as used herein is intended to include all manner of information that could be employed by a user, including but not limited to, a user ID, password, or any other related or unrelated information, such as the novel “Armor Code” referred to herein) from a user, generating a one-way mathematical value (e.g. such as a hash generated value) based on said identity indicia, generating at least a portion of a user friendly representation of said one way hash value, and communicating to said user said at least one portion of said user friendly representation upon said generating of same, and a system for accomplishing the same through the means described herein. The invention also includes the concept of scanning logs, transactions, and/or activities on business systems for suspicious activity in an effort to take action and prevent phishing and other related and unrelated fraud. Thus, the present invention is, inter alia, a double-layered anti-phishing solution that prevents fraud such as phishing from occurring in the first instance, and also reduces the possibility of damage to users who may have been phished (or to organizations whose users have been phished), in the unlikely event that the initial protections described herein are defeated or otherwise not employed. The initial protections are such that the inventive system and method provides for employment of the described protections when the user initially sets his identity indicia (typically a user name and password, although other information may easily be considered within the scope of the invention and an Armor Code or set of Armor Codes may be used) with a given transaction entity. Upon the completion of the setting of his identity indicia, the proper, user-friendly (e.g., easy to recognize as familiar) representation (most preferably visual or visual combined with audio, although additional representations, such as audio or other means may also be utilized) of a hash value is generated based on that identity indicia or associated string of text. If the initial (or, if the user changes his credentials at any time in the future) setting is done online it will appear immediately, or if it is set by a helpdesk representative, then the representative would see the representation and would be able to notify the user as to what representation he may expect to see. Accordingly, when a user initially registers with the online site (and for each existing user after the system is initially deployed) the user will be able to enter text and will then be shown an easy-to-recognize representation (or hear a sound/words/etc or both) that will be easy to remember, and will remain constant until any changes are made to the identity indicia (e.g., subsequent change of name, password, etc.). If an Armor Code is used the user will have the opportunity to test text to see/her the appropriate corresponding representation. However, it is important to note that neither the text he chooses, nor the resulting hash value and representation are stored anywhere on any computer. If an Armor code or other text is used, the user may in fact remember the representations for as many different strings of text as he wants and may not have to use the same one each time he test the system; similarly, a user could test the system and check that the correct corresponding representation is displayed with a password that is not his genuine password for login purposes, and after verifying the correctness of the representation go back and enter his correct password.

In one preferred embodiment, when the user logs into an online system employing the inventive system and method, he will enter the same text before entering his user ID and Password and will be presented with that same easy-to-recognize visual/audible hash representation. Alternatively, the user may see that information as he enters his user ID and password. In either case, the hash would initially be calculated after several x numbers of characters have been entered (either the entire user ID and some in the password, just the user ID, just from the password, from an Armor code, etc.) and then repeated (either using the same function, a different function, with the same or a different key/seed value—the key could be implemented as a classic key or could be simply text appended/mixed in with the text to be hashed) after each additional y number of characters. Alternatively the key may be used with a separate encryption algorithm before running the hash (or other one-way) function. (In such as case the encryption algorithm could even be a simple algorithm such as a derivative of transposition or shifting.) Other “key” implementations may also be possible. The visual/audible representation would either be replaced after each subsequent hash calculation with a representation of the new hash result, or would be “built” with additional elements added after each calculation. For example: the first representation could be the outline of a shape, the second a color filling for the shape, the third the outline of a letter on top of the shape with a white/black filling, and the fourth a color for the letter. Or, each has calculation could add a digit to a number, e.g., after the first hash one digit is displayed, after the second digit is appended to the first digit, etc. Hence, the hashing will be done on the fly for each given identity verification attempt (i.e., log-in), so that identity indicia such as a user ID and password or text information might be entered online by the user, and as the keystrokes are received by the transaction entity (in many cases, a transaction entity will typically be a financial institution or other organization with an on-line presence, although many other institutions, such as service providers of all types, commercial or medical concerns, etc., are all entities contemplated within the scope of the possible applications of the present invention) the hash representation for his identity indicia (user ID and password, etc.) combination will be progressively displayed as confirmation is established in an iterative fashion. This could also be done on the Armor code or any other information.

One of the important aspects of an embodiment of the present invention is to represent values derived from one-way mathematical functions in the form of something user friendly, like an image or audio. To this end, the present invention converts an ostensibly non-user friendly mathematical value into something that can be easily used, consciously or subconsciously memorized, and later recognized by a user. To this end, a simple visual representation system such as colored letters, numbers, symbols, or pictures, etc. on colored shaped backgrounds simplifies the experience for users, makes remembering the proper representation easy, allows for technical support to provide similar authentication over the phone when resetting passwords (and provide the new hash representation after resetting), and facilitates building “images” based on the sequence of hash values as users types in words. Alternatively, numbers could be “built” or words used, but any visual representation will work, and to this end, other potential representations of the hash value might, in alternate embodiments include a simple background color (with or without changing the color of text on the display), changing the color of the text on the display, showing a word(s), photograph(s)/cartoon type image(s), or even multiple representations or combinations of the above. Similarly, an audible representation could be used (different tones, sets of tones, song snippets, “spoken” dictionary word etc.) in alternate embodiments, through computers or phone-based systems. Many other possibilities exist. The point is to use some easily human-recognizable and distinguishable representation of a mathematical value to prove that the party on the other side of a conversation or online verification process is the entity that it claims to be. In one preferred embodiment, a very simple single character visual representation (such as a colored letter, number, background, or simple geometric shape) is used, perhaps in combination with a “spoken” dictionary word or colored background, so as to minimize the extent of the visual representation that must be memorized by a given user, although more characters, elements, gray scales, fill patterns, or color ranges may be employed as desired. Either way, by employing a user-friendly, easily remembered/recognized representations, a simple visual representation uses human psychology to its advantage, given that simple visual representations—like colored letters or a colored background—are easily remembered or at least recognized as familiar by most humans. The same is true for some audible representations, and the combination of both visual and audible cues makes easier recognizing whether the response presented to the user is, in fact, familiar. Despite this apparent simplicity though, the numerous combinations possible within such a “simple” scheme, do not pose security risks like maintaining lists of passwords (especially if such passwords are presented to users prior to full authentication) and other prior approaches often do.

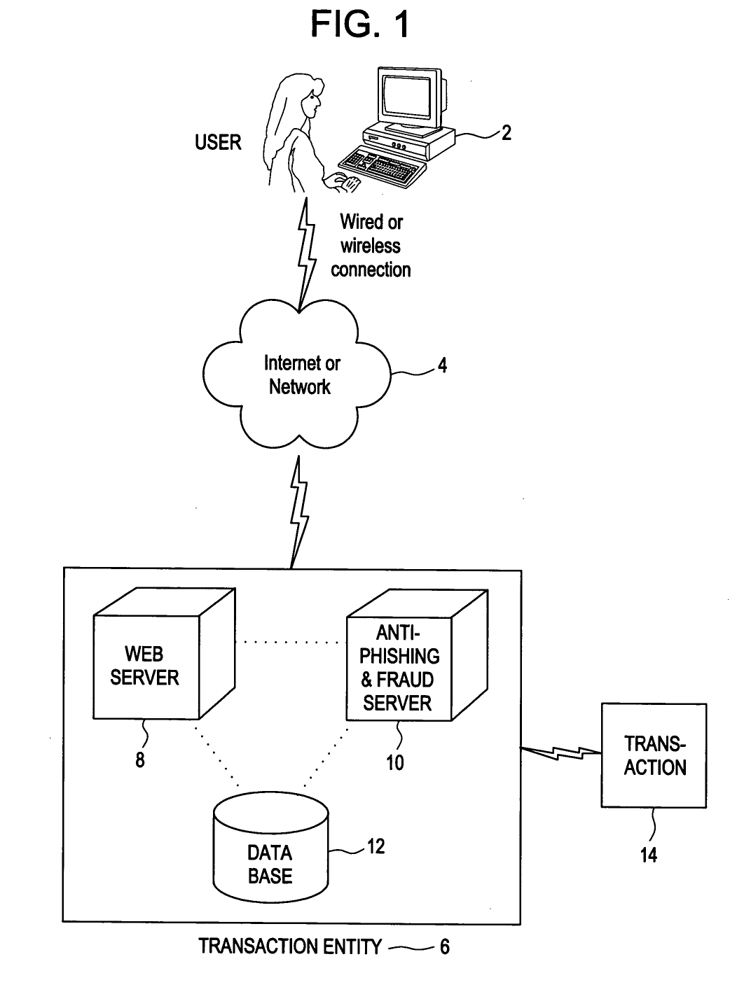

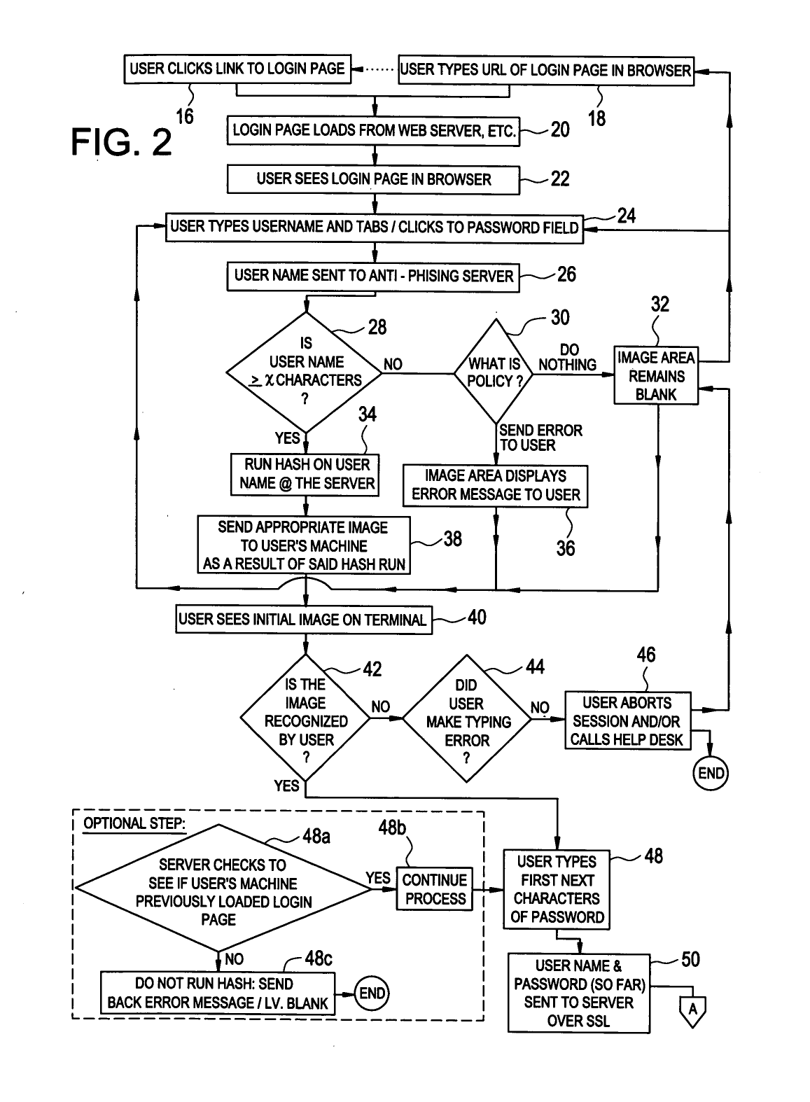

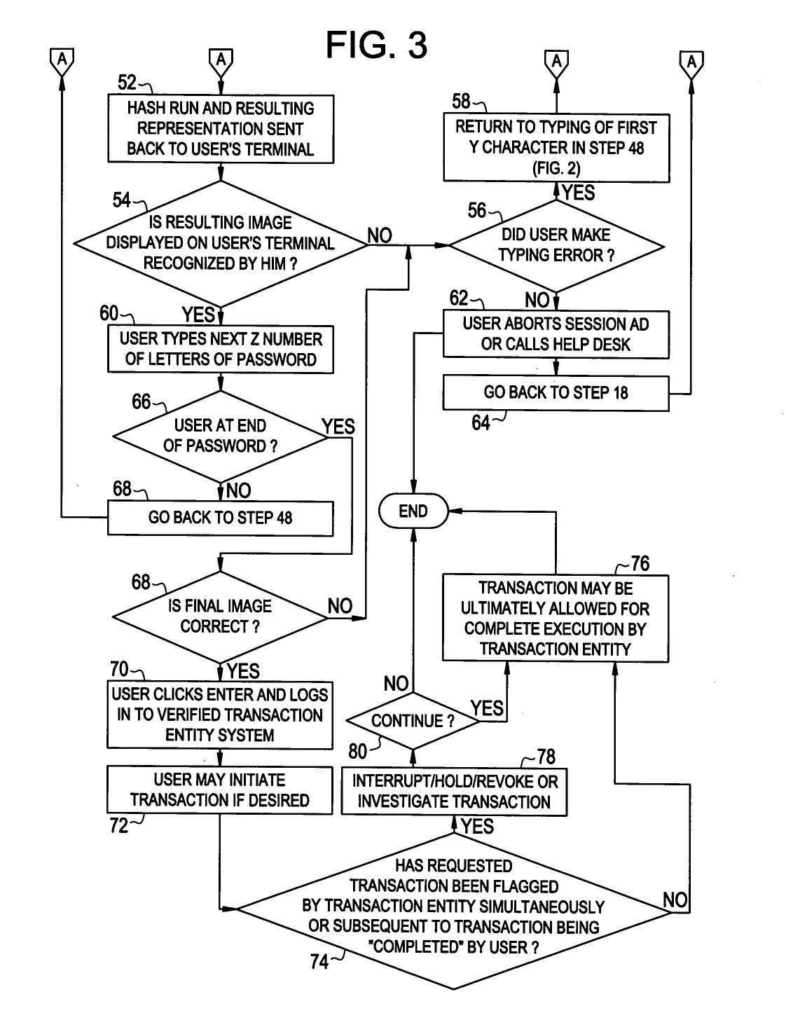

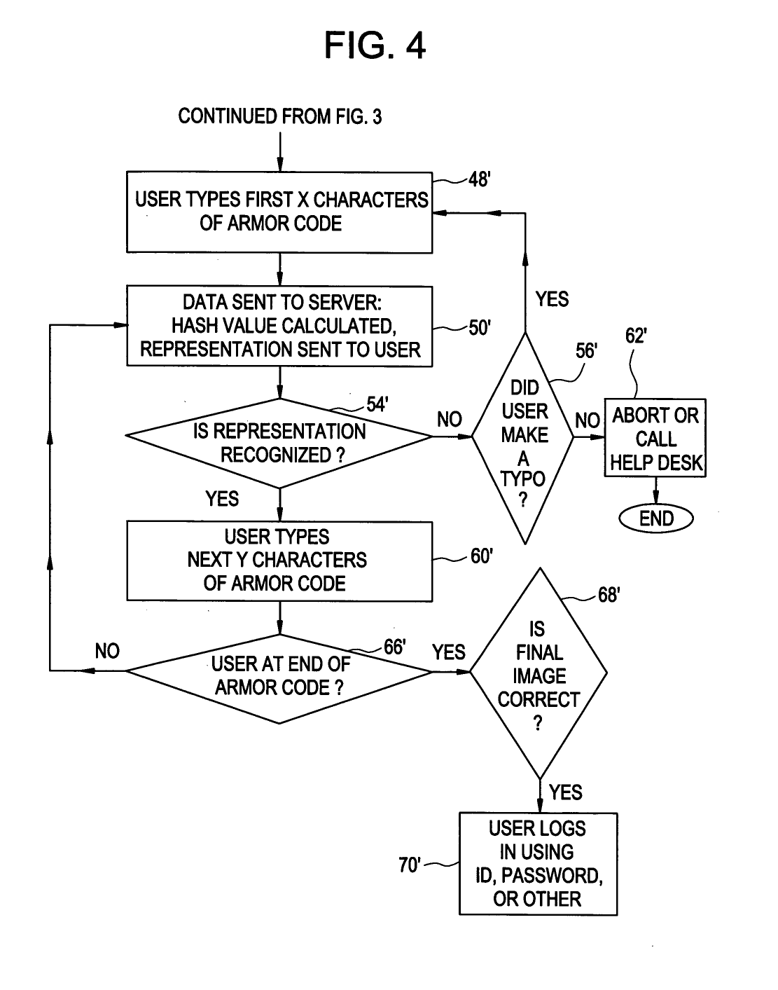

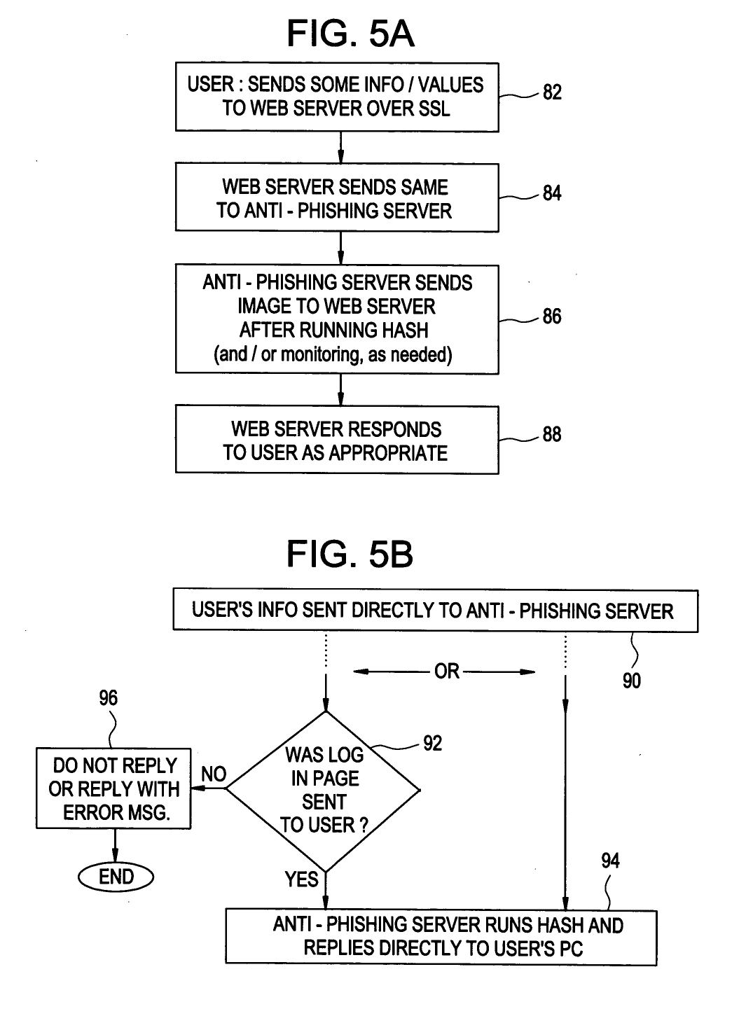

In order to accomplish the above, as one example of a possible implementation, FIG. 1 depicts how the user 2 may interact with transaction entity 6 through a network means 4 so that both actors receive and transmit respective signals from each other as generally illustrated in the illustrative flow diagrams in FIGS. 2-6, which may include optional variants therein. Some variants are depicted in FIGS. 4, 5A, 5B, and partially within FIG. 2. As understood, these signals and the processing as described herein represent the technical effect of transforming user and transaction entity security needs into a seamless, verifiable reality. By way of general reference, the overall process of the present invention may be seen in of FIGS. 2-3 which exemplify how the inventive approach will protect users from being phished, or subject to other variants of fraudulent activity. In its broadest description, these flow diagrams depict illustrative steps wherein: a user loads login page; a user types his login name; a hash/one-way function is then run on his login name; a visual representation is displayed to the user; a user recognizes the visual representation (and thereby continues the process), or alternatively, a user does not recognize the visual representation (and thereby aborts the process or contacts customer service); then, a user begins typing his password such that after x number of characters (which in one preferred embodiment may be 4 characters, although other numbers may also be used), and then hash is run on the y number of characters representing the entire text already submitted including the user name (or on the portion of the password already typed) so as to continue progressive verification by sending further visual representation details so as to build out the overall visual representation so that the user may thereafter continue with the log-in and effectuate transaction as he deems appropriate, although as one skilled in the art will appreciate, this is just one example, and it is possible to readily modify the invention to many other possible variants of the present invention.

Accordingly, only the user (and not the server, nor the browser software) knows if the representation (image, number, word, letter, background color, sound, word read, music clip, etc.) displayed and/or heard is correct, thereby eliminating the chance that fraudulent actors might access a cache, hard drive, or other storage facility for passwords or other protection keys. In fact, the user need not remember exactly what the representation is as he would with a password or pass-image, but, rather, just be able to determine if what he is shown is familiar to him—i.e., has he seen it before when logging in. To this end, the hash value is generated using a function and secret key available only to the legitimate server (the key may be implemented as simply as a string of text added to the text the user submits or using other mechanisms as described earlier) and would be the same each time the user logs in: if the representation is the one the user expects, then he knows the system is authentic. (the key may be stored in encrypted form or otherwise protected on the anti-phishing server.) The hash may be progressively formed or built out through an iterative or recursive function, that is, a routine may be provided whereby the hash could be performed on the user's ID and password as he types (starting with the aforementioned several characters of the password) and he could watch the image being built as he goes. If any steps along the way are not correct (e.g., the shapes/letters, colors, etc. are not what the user remembers them to be) then the user knows to stop typing, as the identity of the transaction entity is not confirmed. (There may be a message to this effect on the login page and the user will be educated to this effect when he initially logs in and a message instructs him to this effect. Periodic reminders may also be sent to him on bank statements, health insurance benefits statements, and other correspondence.) The image may be built as the user types (and the user would therefore see it have additional elements added as he types more characters) or after he has finished entering data into the field in questions. In one preferred embodiment, after the user enters first four characters of his password: image items are added to the shape (colors, patterns, letter, etc.) after every few characters, wherein all elements may be based on one-way hashes. In another embodiment, the hash function or one-way function is called only once—and resets the color of the background. In another it is called twice—once to set the background and once to set the color of the text (which is also influenced by the background color—i.e., the actual color range for each value changes based on the background). Other objects could also be modified in a other manners to indicate the representation. The inventive system and method uses software routines to generate a series of one-way hash functions that can be run either while the user types (e.g. for passwords), or alternatively, after the user types (e.g. for Armor Codes, as depicted illustratively in FIG. 4 The Armor Code is not a special code, but rather the name we are using for any text the user chooses to use for confirming the identity of the server with whom he is interacting. The user types the string of text and the hash/1-way function is run on the text and the resulting representation presented to the user. Armor Code allows the user to test for system authenticity, even before typing his login name.). In one embodiment, the hash algorithms can include unique keys added to the text to be hashed or used for a simple encryption scheme before performing the hash, or, if the algorithm used for hashing allows, in initialization vector-like starting values/keys. The use of a server-based key as depicted herein is such that even if an external party knows the nature of the hash function being used, he will be unable to figure out what the valid representation response is for any given user or input. It should be noted that the hash function could be applied against a dedicated text field that is not a username or password (e.g., the Armor Code), but which is used for the sole purpose of checking the legitimacy of the system before entering any credentials. The present invention may further provide for a (separate or same) key that contains the server name, IP address, network name, etc. for licensing and security reasons. This key ensures that even if hacker stole the key, anti-phishing/fraud system, and the initialization key, he would not be able to use it, because the licensing key would prevent the server from running on machines other than those at the legitimate institution (or at least would make it very difficult to do so in a manner that the legitimate institution would remain unaware of its being abused in such a fashion). In terms of licensing reasons, the key is afforded so that the inventive solution cannot be used on unlicensed servers so as to prevent software piracy and its associated losses.

Those skilled in the art will appreciate that the present invention is flexible enough to provide for a trade-off between simpler representations (typically offering somewhat less protection from impersonation by phishers and/or other parties) and more complex representations (typically involving relatively more security). However, even with a very simple implementation of the invention by which the background color of the user's display is changed to one of 10 basic colors after running a single has function, there is a 90% chance that the site cannot be properly impersonated. As representation grow more complicated the likelihood of a phisher successfully impersonating the legitimate site approach 0. The more noticeable the modification to the login page (or other user experience components) the more likely that the user will notice. Within this framework, another configuration of the representation would be to use a visual representation involving approximately: 10 shapes; 10 colors/patterns; and 36 alpha-numeric characters. Such a range of possible variable elements means at least 3,600 representations, not counting possible further variations with background colors, audio, other characters, advanced colors/patterns, angles of rotation, multiple letters, etc. More complicated representation schemes with additional variable components may be used. Thus, the total configuration can be scaled to enormous numbers of possible combinations, thereby rendering impersonating of the same practically impossible, yet simple enough for a user to both recognize and use on an ongoing basis (thereby obviating concerns about technological and/or practical shortcomings of known anti-fraud systems).

As mentioned, the present invention is applicable to additional on-line verification/anti-fraud applications. One such additional application is to combat those fraud techniques covered under the name “man-in-the-middle.” In combating man-in-the-middle problems, it is useful in one embodiment to afford the following within the scope of the inventive system: restricting the serving of images to IP addresses or machines (as determined through cookie usage) to those that have already requested the login page; tracking the number of different unique hash requests per IP address, utilizing “cookies,” and using public/private keys (in order to make it impractical to broker requests). When used in this manner, these technologies can also prevent hackers from trying to obtain list of hash codes by issuing repeated hash requests, thereby combating some brute force attacks (although it must be noted that the invention herein does not require any saving of sensitive data (e.g., passwords) on the transaction entity server, and that to be effective for phishing would require generating a very large list of hash results that is likely impractical to do even without these technologies in place.). Moreover, it will be appreciated by those skilled in the art that certain aspects of the continuum described herein may be utilized individually for other applications (e.g., the log, activity, and transaction monitoring may be utilized by itself, if desired, to monitor various forms of fraud, while the initial log-in verification stage may be used for other purposes as needed.

In this regard, the present invention is not limited to a “one-shot” approach to identity verification, in that it provides a true continuum of identity verification, beginning with the initial verification described above, and continuing with verification of identity veracity for the issuer of transactions/activities during and after the pendency of any transaction/activity that may have been initiated as a result of the identity confirmation at the initial stage or in spite of it or prior to its implementation. Note that the first identity verification is the server to the user. The second is user to server.? Hence, in the rare cases where a fraudulent actor may have been able to trick a user through any means (phishing, social engineering, or otherwise) to surrender to him sensitive access credentials, the present invention will conduct transaction/activity/log monitoring by monitoring logs/activities/transactions and/or the nature of the individual or aggregated transactions themselves to provide an extra level of protection against fraud Regarding the initial identity verification (as opposed to the activity monitoring), the system described as such will also guard against both man-in-the-middle attacks (in which the phisher has users come to his site and relays specific data to the real server in order to obtain the correct responses), and situations in which phishers attempt to generate large hash result tables using brute force techniques. To this end, the inventive system and method could monitor and act upon unusual usage patterns (for example, by identifying many requests from the same system with different values to be hashed).

Thus, the log scanning/transaction monitoring/activity monitoring is an additional important feature of the present invention, and may even be applied to many forms of online fraud beyond phishing, and may even be just used to see if any phishing activity has occurred, regardless of user involvement with the above-described log-in verification. Because the inventive approach provides for the scanning of transaction logs to detect suspicious activity in a given or over a multiplicity of transactions, it is akin to an “identification” for phishing and other forms of online fraud. Because it detects phishing or other fraud after it has occurred, it affords both the legitimate user, and the associated transaction entity a true continuum of protection found nowhere else: in certain cases, the scanning may be scheduled to occur within the time period of a transaction pendency so as to be able to reverse or hold transactions with minimized loss. Upon detection, an alert may be issued to appropriate personnel to verify the authenticity of the transaction, the systems issuing the transactions may be blocked from future access, or other policies may be activated. The account with the transactions may be locked to prevent further exposure. Additionally, the system can track a phisher (by obtaining the IP address from which the request was made and tracing the route back to it) shortly after crime so as to afford one a greater likelihood of catching the fraudster(s) involved.

Accordingly, by way of one illustrative example, if scanning of business activity logs is enabled, multiple transactions involving outgoing transfers of money (or other forms of “spending” that may form irregular patterns as understood by those skilled in the art of fraud patterns) may trigger a system alert, or cause specific IP addresses to be temporarily blocked as described above. This would work using one of several possible techniques. For example, in one exemplary embodiment, activity logs may be scanned periodically (perhaps several times per day, or more often as dictated by the needs and/or business of the transaction entity) in order to search for suspect activity. Examples of such activity and scanning would be looking for “outgoing” transactions from multiple accounts issued from a single IP address, outgoing requests initiated from addresses in one region when the user accounts are all in another region, etc. To this end, the transaction entity may set some predetermined rules or thresholds according to industry standards and entity needs that may be embodied as routines within the computerized system that will react when a set limit is reached or when a type of transaction occurs, etc. When the computerized system reacts to such a transaction or transactions as being suspect according to the predetermined rules therein, they then may be flagged. Once flagged, the system may disallow, restrict, or set aside the flagged transactions for further examination, such as by humans who might be able to examine them and determine if they are legitimate, or the result of someone having being phished or otherwise tricked into surrendering access information Once such a determination has been reached, it may then be possible to allow the flagged transaction(s) to continue, or they can be continually/on-a-one-time-basis disallowed, rescinded, or set up for further verification (for example, by contacting the account owner to see if the transaction(s) were in fact made by him). This functionality is particularly useful in the case of certain transactions that may take time to “clear” because of industry custom or because of technological and/or logistical limitations (e.g., financial transactions such as securities sales, wire transfers, etc. that have settlement periods of a day, etc.), as those transactions may be further subject to a practical form of verification through the inventive monitoring whereby a fraudulent transaction may be revoked, investigated, etc. By contrast, however, the monitoring may be done on a real time basis in order to satisfy transaction needs. For example, in one embodiment, the present invention provides for the performing of a real time analysis of the transactions that occur, in order to check for legitimacy, so that anything deemed potentially illegitimate can be blocked, delayed, or subject to (possibly immediate) scrutiny by automatically notifying a human to look into the propriety of the transaction. The real time approach may be accomplished by either tighter integration of the anti-fraud/phishing system with the business systems or via reading the details of every activity/transaction from the activity logs as they occur rather than reading this information periodically as described earlier. Previous transaction information may be considered as part of the analysis process. Furthermore, it should be noted that the monitoring solution is applicable across verticals.

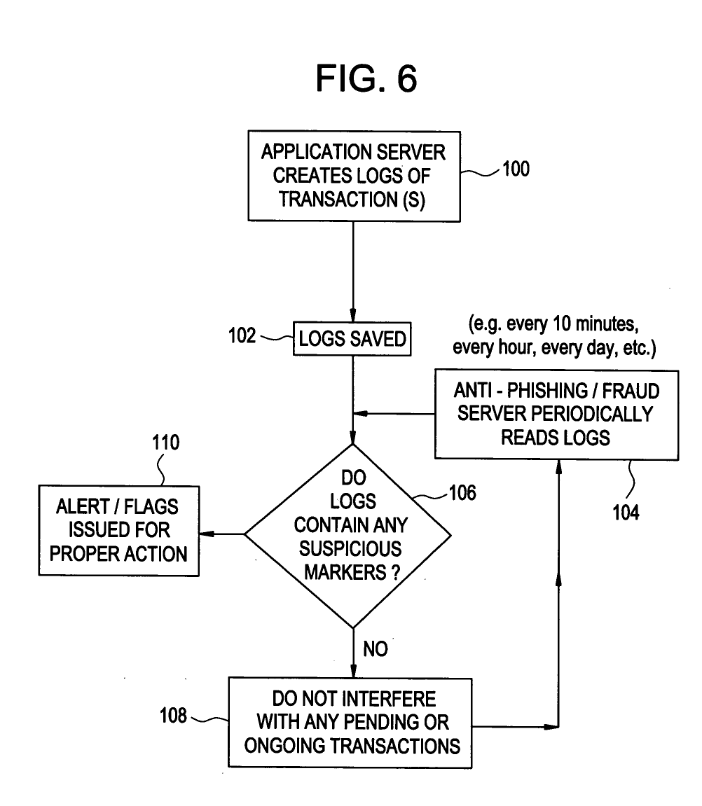

Thus, by way of illustrative flow diagram FIG. 6, the present invention is able to offer an exemplary approach to reducing the impact of fraud resulting from attempts by phishers and other criminals to exploit access information obtained through phishing, other forms of social engineering, or any other method. Criminals may attempt to execute the following steps: the user (criminal) performs a transaction using the online system; the transaction is logged; and the anti-phishing server periodically scans the logs and looks for anomalous patterns that may indicate phishing and/or other forms of fraud. Anomalous transactions might include patterns indicating transactions to effectuate outgoing transfers from different users' bank accounts made from the same IP address, (if not previously determined to be legitimate as in the case of a proxy and multiple users of a large corporation, which ideally should nevertheless be checked so that known proxies may be accounted for in the future if they are determined to be legitimate and to reduce the risk of someone issuing fraudulent transactions using a proxy address or through such a proxy). Other suspicious patterns might involve multiple requests for has representations from the same IP address (if not established as requesting such for a legitimate reason), and whether a given IP address has not recently loaded a log-in page (such instances may indicate fraudulent intervention within the process—including man-in-the-middle type issues, and as such, it is often best to avoid serving images to IP addresses that did not recently load the login page). To this end, if such patterns are detected, the transactions that are suspect are flagged and an administrator is summoned/notified to look at them (or other corrective actions are taken).

Although known phishing scams have generally lacked sophistication in terms of combining their tricks with additional fraudulent techniques, it is nevertheless likely that phishers will improve their techniques with time. For example, it is conceivable that phishers might utilize pilfered versions of say, the inventive system. The present invention further contemplates an enhanced utilization of the above-described inventive techniques, such that the inventive solution is, in an alternate embodiment, armed with the capability to combat the aforementioned future threats. Some of the techniques to combat such threats have been described earlier. Additional technologies that may be utilized to this end (and to combat man-in-the-middle and other potential attempts at fraud) include the use of: binding keys used for hashing to server names; checking SSL session IDs (perhaps encrypted); verifying IP numbers, comparing SSL certificate IDs to the ID of the server sending the image, utilizing cookies, etc.

It is to be understood that the invention is not limited to the illustrations described and shown herein, which are deemed to be more illustrative of several of the anticipated best modes of carrying out the invention, and which are susceptible of modification of form, size, and arrangement of parts and details operation. These modifications are within the spirit and scope of the appended claims.

1. A method for representing a mathematical value in a user friendly way for use within an electronic system, comprising the steps of:
receiving identity indicia from a user;
generating a one way hash value based on said identity indicia;
generating at least a portion of a user friendly representation of said one way hash value;
communicating to said user said at least one portion of said user friendly representation upon said generating of same.

2. The method of claim 1 wherein said representing of a mathematical value in a human friendly way is utilized for effectuating online identity authentication.

3. The method of claim 2, wherein the step of receiving identity indicia from a user comprises an iterative reception of said identity indicia from said user based upon a continuing recognition of each of said at least one portion of said user friendly representation upon said generating of same.

4. The method of claim 3, wherein the step of generating the user friendly representation of said one way hash value comprises the step of generating a visual representation for display on a terminal of said user upon said communicating of said at least one portion of said user friendly representation.

5. The method of claim 4, wherein the step of generating said visual representation for display on said user's terminal upon said communicating of said at least one portion of said user friendly representation further comprises the step of generating said visual representation chosen from the group comprising geometric shapes, letters, numbers, freeform shapes, and pictures.

6. The method of claim 5, wherein the step of generating said step of generating said visual representation further comprises the step of generating at least one of the following comprising a color or a pattern associated with at least one of said visual representations.

7. A method for verifying transactional veracity by receiving identity indicia from a user and associating transactional and source information associated with said identity indicia.

8. The method of claim 7, further comprising the step of monitoring said transactional, activity, and source information associated with said identity indicia for possible fraud.

9. The method of claim 8, further comprising the step of flagging any possible fraud as determined during said step of monitoring said transactional and source information associated with said identity indicia for possible fraud, for disposition in accordance with predetermined rules.

10. A computer-readable storage media that contains a program that when executed by a computer represents a mathematical value in a user friendly way and verifies on line identity on a system by performing the steps of:
receiving identity indicia from a user;
generating a one way hash value based on said identity indicia;
generating at least a portion of a user friendly representation of said one way hash value;
communicating to said user said at least one portion of said user friendly representation upon said generating of same.

11. The computer-readable storage media of claim 10, wherein the step of receiving identity indicia from said user further comprises routines for providing an iterative reception of said identity indicia from said user based upon a continuing recognition of each of said at least one portion of said user friendly representation upon said generating of same.

12. The computer-readable storage media of claim 11, wherein the step of generating the user friendly representation of said one way hash value comprises a routine for effectuating the step of generating a visual representation for display on a terminal of said user upon said communicating of said at least one portion of said user friendly representation.

13. The computer-readable storage media of claim 12, wherein the routine for effectuating the step of generating said visual representation further comprises at least one of the following routines for generating a color or pattern associates with at least one of said visual depictions.

14. The computer-readable storage media that contains a program that when executed by a computer runs a routine for receiving identity indicia from a user and a routine for associating transactional and source information associated with said identity indicia.

15. The computer-readable storage media of claim 14, further comprising a routine for effectuating the step of monitoring said transactional and source information associated with said identity indicia for possible fraud.

16. The computer-readable storage media of claim 15, further comprising a routine for effectuating the step of flagging any possible fraud, as determined during said step of monitoring said transactional and source information associated with said identity indicia for possible fraud, for disposition in accordance with predetermined rules.

17. An apparatus for on-line identity authentication for an electronic system, comprising:
means for receiving identity indicia from a user;
means for generating a one way hash value based on said identity indicia;
means for generating at least a portion of a user friendly representation of said one way hash value; and
communicating to said user said at least one portion of said user friendly representation upon said generating of same.

18. The apparatus of claim 17, wherein the means for receiving identity indicia from a user further comprises: means for providing an iterative reception of said identity indicia from said user based upon a continuing recognition of each of said at least one portion of said user friendly representation upon said generating of same

19. The apparatus of claim 18, wherein the means of generating the user friendly representation of said one way hash value further comprises a means for generating a visual representation for display on a terminal of said user upon said communicating of said at least one portion of said user friendly representation.

20. The apparatus of claim 19, wherein the means for generating said visual representation chosen from the group of visual depictions further comprises a means for generating a color or pattern associates with at least one of said visual depictions.

21. The apparatus of claim 20, wherein the means for receiving said identity indicia from said user further comprises a means for associating transactional and source information associated with said identity indicia.

22. The apparatus of claim 21, further comprising a means of monitoring said transactional and source information associated with said identity indicia for possible fraud.

23. The apparatus of claim 22, further comprising a means for flagging any possible fraud, as determined during by said means for monitoring said transactional and source information associated with said identity indicia for possible fraud, for disposition in accordance with predetermined rules.

24. A method for representing a mathematical value in a user friendly way and for on-line identity authentication for an electronic system, comprising the steps of:
transmitting identity indicia associated with a user to an online transaction entity;
receiving a one way hash value that has been generated by online transaction entity based on said identity indicia;
receiving at least a portion of a user friendly representation of said one way hash value as generated by said online transaction entity;
determining on line identity of said online transaction entity based on said receiving of said at least one portion of said user friendly representation upon said generating of same.

25. The method of claim 24, wherein the step of transmitting identity indicia from a user to said online transaction entity comprises an iterative reception of said identity indicia from said user based upon a continuing recognition of each of said at least one portion of said user friendly representation upon said generating of same.

26. The method of claim 25, wherein the step of receiving the user friendly representation of said one way hash value comprises the step of receiving a visual representation for display on a terminal of said user, upon said communicating of said at least one portion of said user friendly representation.

27. The method of claim 26, wherein the step of receiving said visual representation for display on said user's terminal upon said communicating of said at least one portion of said user friendly representation further comprises the step of receiving said visual representation chosen from the group of visual depictions comprising geometric shapes, letters, numbers, freeform shapes, and pictures.

28. The method of claim 27, wherein the step of receiving said visual representation chosen from the group of graphical depictions further comprises the step of receiving a color or pattern associates with at least one of said visual depictions.

29. The method of claim 28, wherein the step of transmitting said identity indicia from the user further comprises transmitting transactional and source information associated with said identity indicia.

30. The method of claim 4, wherein the step of generating said user friendly representation for display on said user's terminal upon said communicating of said at least one portion of said user friendly representation may further include the step of generating said user friendly representation by effectuating at least one of the actions chosen from the group comprising: changing a background color, displaying an image, modifying text color, modifying elements on a display, shading a background with different patterns, playing recognizable music, playing recognizable tones, playing a generated word, displaying a generated word, displaying a number, or displaying combinations of the same.

31. The computer-readable storage media of claim 11, wherein the routine for effectuating the said user friendly representation for display on said user's terminal upon said communicating of said at least one portion of said user friendly representation may further include the step of generating said user friendly representation by effectuating at least one of the actions chosen from the group comprising: changing a background color, displaying an image, modifying text color, modifying any elements on the display, shading a background with different patterns, playing recognizable music, playing recognizable tones, playing a generated word, displaying a generated word, displaying a number, or displaying combinations of the same.

32. The apparatus of claim 18, wherein the means for effectuating the said user friendly representation for display on said user's terminal upon said communicating of said at least one portion of said user friendly representation may further include the step of generating said user friendly representation by effectuating at least one of the actions chosen from the group comprising: changing a background color, displaying an image, modifying text color, modifying any elements on the display, shading a background with different patterns, playing recognizable music, playing recognizable tones, playing a generated word, displaying a generated word, displaying a number, or displaying combinations of the same.

33. The method of claim 26, wherein the step of generating said user friendly representation for display on said user's terminal upon said communicating of said at least one portion of said user friendly representation may further include the step of generating said user friendly representation by effectuating at least one of the actions chosen from the group comprising: changing a background color, displaying an image, modifying text color, modifying any elements on the display, shading a background with different patterns, playing recognizable music, playing recognizable tones, playing a generated word, displaying a generated word, displaying a number, or displaying combinations of the same.

34. The method of claim 2 used specifically to combat phishing type fraud.

35. The method of claim 8 used specifically to combat phishing-type fraud.

36. The computer-readable storage media of claim 16 used specifically to combat phishing-type fraud.

37. The apparatus of claim 22, used specifically to combat phishing type fraud.
